(19) United States
(12) Patent Application Publication
(10) Pub. No.: US 2024/0259922 A1
(43) Pub. Date: Aug. 1, 2024

(54) ELECTRONIC DEVICE

(71) Applicant: Nordic Semiconductor ASA, Trondheim (NO)

(72) Inventors: Tuomo KUMENTO, Oulu (FI); Aki RANTALA, Oulu (FI)

(73) Assignee: Nordic Semiconductor ASA, Trondheim (NO)

(21) Appl. No.: 18/427,652

(22) Filed: Jan. 30, 2024

(30) Foreign Application Priority Data
Jan. 31, 2023 (GB) 2301358.4

(51) Int. Cl. H04W 48/16; H04W 48/14

(52) U.S. Cl. CPC H04W 48/16; H04W 48/14

(57) ABSTRACT

An electronic wireless communication device arranged to connect to a first wireless network of a plurality of wireless networks. The device includes a status indicator having at least two values, comprising a first value indicating that the electronic wireless communication device is assigned a status as a moving device and a second value indicating that the electronic wireless communication device is assigned a status as a stationary device. The device is arranged to periodically search, at intervals defined by a search period, for available networks of the plurality of wireless networks, other than the first wireless network to which the electronic wireless communication device is connected. The search period has a first period value when the status indicator has the first value and a second period value when the status indicator has the second value. The first period value is lower than the second period value.

### CROSS REFERENCE TO RELATED APPLICATION

This application claims priority from Great Britain Application No. 2301358.4, filed Jan. 31, 2023, which application is incorporated herein by reference in its entirety.

### TECHNICAL FIELD

The present invention relates to an electronic wireless communication device, a wireless communication network, a communication system including an electronic wireless communication device in communication with a wireless communication network, and associated methods.

### BACKGROUND OF THE INVENTION

It is known for electronic wireless communication devices connected to wireless voice and data networks to search periodically for available networks, other than the network to which they are currently connected, which they might connect to instead (e.g., if one of the other networks is assigned a higher priority). These periodic searches may be conditional on the device not already being connected to the highest priority network in the region that the device is located in (e.g., the highest priority network in the country). In other words, if a device is already connected to the highest priority network for the country it is in, it will not carry out periodic searches for other networks, otherwise the periodic searches are mandatory for a roaming device. It is known for such devices to include a subscriber identity module (SIM) (for example a universal integrated circuit card (UICC)), which may be virtual or physical. A network provider will provide the SIM, and can configure on the SIM settings for the interval which the device is to use for periodic searches. The SIM may also be configured with the relative priorities of a number of networks.

The interval at which an electronic device periodically searches for other available networks is therefore pre-determined by the network provider associated with the SIM. Since the network provider has limited control over which devices a SIM is subsequently installed in, it is possible that the search period defined on the SIM is not appropriate for the particular device in which the SIM is used. The present invention seeks to provide improvements to this known arrangement.

### SUMMARY OF THE INVENTION

From a first aspect, the invention provides an electronic wireless communication device arranged to connect to a first wireless network of a plurality of wireless networks, the electronic wireless communication device comprising:
a status indicator having at least two values, comprising a first value indicating that the electronic wireless communication device is assigned a status as a moving device and a second value indicating that the electronic wireless communication device is assigned a status as a stationary device;
wherein the electronic wireless communication device is arranged to periodically search, at intervals defined by a search period, for available networks of the plurality of wireless networks, other than the first wireless network to which the electronic wireless communication device is connected; and
wherein the search period has a first period value when the status indicator has the first value and a second period value when the status indicator has the second value, and wherein the first period value is lower than the second period value.

From a second aspect, the invention provides a method of operating an electronic wireless communication device, comprising:
assigning a status indicator of the electronic wireless communication device a value, of at least two values, the at least two values comprising a first value indicating that the electronic wireless communication device is assigned a status as a moving device and a second value indicating that the electronic wireless communication device is assigned a status as a stationary device;
connecting the electronic wireless communication device to a first wireless network; and
the electronic wireless communication device searching periodically, at intervals defined by a search period, for available networks of the plurality of wireless networks, other than the first wireless network, wherein the search period has a first period value when the status indicator has the first value and a second period value when the status indicator has the second value, and wherein the first period value is lower than the second period value.

The value of the status indicator may be assigned before or after the electronic wireless communication device connects to the first wireless network.

Thus it will be seen that, in accordance with the invention, by varying the length of the interval at which the device searches for other available networks (other than the one to which it is already connected), based on whether the electronic wireless communication device is assigned a status as a moving device or a stationary device, the power consumption of the device for the purposes of these searches can be optimized. Where a device is moving (e.g., being carried by a person who is travelling) it may often move into range of a new network, and therefore regular searching is important for such a device so that it can be connected to the most appropriate, or desirable, of all the available networks. In contrast, where a device is stationary it is very unlikely that a new network will become available, or suitable, for the device. For example, this might only occur if a new network is created in the vicinity of the device, or if the properties or priorities in relation to the existing networks in the vicinity of the device are changed. Thus, there is no benefit to a stationary device using power to search very regularly (i.e., at short time intervals) for new available networks. The claimed arrangement allows devices which are recognized, or configured, as stationary devices, to search less frequently for alternative networks, thereby conserving power which would otherwise be wasted on unnecessary searching, whilst also ensuring that moving devices search sufficiently often for new networks.

By way of example, the first period value may be less than 6 hours, optionally less than 3 hours, further optionally less than 2 hours, further optionally less than 1 hour, further optionally less than 30 minutes, further optionally less than 15 minutes. In some examples, the first period value may be (approximately) 6 hours, optionally (approximately) 4 hours, further optionally (approximately) 2 hours. The second period value may be at least (i.e. more than) 24 hours, optionally 2 days, optionally more than 5 days, optionally up to 40 days, further optionally up to 80 days. The second period value may be approximately 24 hours.

In some embodiments, the electronic wireless communication device comprises a status indication portion, arranged to store the status indicator. The status indication portion may be a register (e.g. a memory register) arranged to store the value of the status indicator.

In some embodiments, the electronic wireless communication device comprises a network search portion, wherein it is the network search portion that is arranged to periodically search, at intervals defined by a search period, for available networks of the plurality of wireless networks, other than the first wireless network to which the electronic wireless communication device is connected.

In some embodiments, the electronic wireless communication device comprises a search period setting portion which is arranged to set the search period based on the value of the status indicator. The search period setting portion may be part of the network search portion, or may be a separate part of the electronic wireless communication device.

The search period value may be set based on the value of the status indicator by retrieving a value for the search period (i.e. the first period value or the second period value) from a memory of the electronic wireless communication device. Thus, the electronic wireless communication device may comprise a memory storing values of the status indicator and corresponding search period values. The method may comprise retrieving a search period value from a memory of the device based on the status indicator and searching periodically for available networks at intervals corresponding to the retrieved search period value.

In some embodiments, the value of the status indicator is variable dynamically (i.e., not only during initial set up of the electronic wireless communication device). This helps the status indicator to provide useful and relevant information about the electronic wireless communication device throughout its lifetime, even if its function is changed during the lifetime of the device. Thus, in some embodiments, the method of operating the electronic wireless communication device further comprises changing the value of the status indicator.

In some embodiments, the value of the status indicator is user configurable (i.e. so that a user is able to vary the status of the electronic wireless communication device between being a moving device and a stationary device). For example, the value of the status indicator may be configurable in an application running on the electronic wireless communication device. Thus, in some embodiments, the method of operating the electronic wireless communication device further comprises setting or changing, by a user, the value of the status indicator.

In some embodiments, the value of the status indicator is configurable based on device data of the electronic wireless communication device (e.g. of sensor data from one or more sensors of the electronic wireless communication device). For example, the value of the status indicator may be configurable based on movement data and/or location data of the electronic wireless communication device, which may be obtained from movement sensors and/or location sensors of the electronic wireless communication device (e.g. GPS sensors). Thus, in some embodiments, the electronic wireless communication device comprises one or more sensors (e.g. movement sensors and/or location sensors). Thus, in some embodiments, the method of operating the electronic wireless communication device further comprises collecting data from at least one sensor of the electronic wireless communication device, and changing the value of the status indicator based on the collected data.

In some embodiments, the value of the status indicator is configurable based on a communication received from an external device over the first wireless network. For example, the electronic wireless communication device may be arranged to change the value of the status indicator based on an instruction received over the first wireless network, e.g. an instruction received from a cloud server. Thus, in some embodiments, the method of operating the electronic wireless communication device further comprises receiving a communication over the first wireless network from an external device, and changing the value of the status indicator based on receiving the communication.

It will be understood that the term “available networks” refers to networks that the electronic wireless communication device is within range of, and is capable of connecting to. The electronic wireless communication device need not necessarily connect to one of the available networks that it identifies (and disconnect from the first network), rather it may carry out some assessment of the available networks before deciding to switch to one of those other available networks in preference to the first network.

In some embodiments, the electronic wireless communication device is arranged to connect to a highest priority network of the available networks identified in a search. The electronic wireless communication device may be arranged to assess a priority of each of the available networks identified in a search, to identify the highest priority network. In some embodiments, the electronic wireless communication device comprises a network priority assessment portion, arranged to carry out one or both of these steps. Thus, if the electronic wireless communication device identifies a higher priority network than the one it is currently connected to (i.e. the first network) in one of its periodic searches then it instead connects to the higher priority network. Thus, in some embodiments, the method of operating the electronic wireless communication device further comprises the electronic wireless communication device identifying a higher priority network than the first network, and as a result, disconnecting from the first network and connecting to the identified higher priority network. The device may be arranged to cease periodically searching for available networks under certain specific conditions. In particular, the device may be arranged to cease periodically searching for available networks (i.e. to not periodically search for available networks) in the event that the electronic wireless communication device is already connected to the highest priority network in the region that the device is located in (e.g. the highest priority network in the country).

The priority of the networks may be defined by the mobile operator associated with the electronic wireless communication device (e.g. based on costs agreed between the mobile operator associated with the device and between operators of the available networks). It will be understood that where a mobile operator is said to be associated with a device, that may be directly, or may be indirectly, by virtue of the mobile operator being the supplier of a subscriber identity module that is present within the device, as discussed further below. The priority order or value of the networks may be defined or configured (e.g. stored) on the subscriber identity module.

The electronic wireless communication device may comprise a memory, comprising a priority order of networks stored in the memory. For example, this may be stored on a circuit card of the electronic wireless communication device. This may allow the electronic wireless communication device to quickly determine whether a network identified as an available network in a search is of a higher priority or a lower priority than the first network to which the electronic wireless communication device is currently connected.

In some embodiments, the electronic wireless communication device comprises a subscriber identity module which assigns an identification to the electronic wireless communication device. The mobile operator associated with the electronic wireless communication device typically supplies the subscriber identity module and may therefore control the contents of the subscriber identity module, and thereby have greater control over the subsequent operation of the electronic wireless communication device. In some embodiments, the subscriber identity module stores a stationary status permission indicator, indicating that the electronic wireless communication device is permitted to have a status as a stationary device. The stationary status permission indicator may comprise at least two values, where a first value indicates that the electronic wireless communication device is permitted to have a status as a stationary device and a second value indicates that the electronic wireless communication device is not permitted to have a status as a stationary device. Alternatively, the absence of a stationary status permission indicator from the subscriber identity module may indicate that the electronic wireless communication device is not permitted to have a status as a stationary device.

In some embodiments, the subscriber identity module stores configuration settings associated with the electronic wireless communication device being assigned a status as a stationary device (and optionally also associated with the electronic wireless communication device being assigned a status as a moving device). For example, the configuration settings may include the second period value. The subscriber identity module may store the first period value. Thus, the subscriber identity module may comprise a memory, storing values of the status indicator, and corresponding search period values. Storing this information in the subscriber identity module may allow the mobile operator associated with the subscriber identity module (and therefore with the electronic wireless communication device containing the SIM) to control the search period that is used when the device has a status as a stationary device.

Thus, the search period may be set based on the value of the status indicator by retrieving a value for the search period (i.e., the first period value or the second period value) from the subscriber identity module (e.g., from a memory of the subscriber identity module) of the electronic wireless communication device. The method may comprise retrieving a search period value from the subscriber identity module of the device, based on the status indicator, and searching periodically for available networks at intervals corresponding to the retrieved search period value.

Alternatively, the electronic wireless communication device may be arranged to receive the stationary status permission indicator in a communication from an external device over the first wireless network. The electronic wireless communication device may comprise a memory (e.g. a status-permission-indicator-memory), which may be RAM, arranged to store the stationary status permission indicator. The device may be arranged to store the received stationary status permission indicator in the memory or the subscriber identity module. In some examples, the electronic wireless communication device may receive the stationary status permission indicator during an attach communication or a tracking area update communication (e.g. a tracking area update request). Thus, the electronic wireless communication device may receive permission in a communication over a network to have a status as a stationary device.

Additionally, or alternatively, the electronic wireless communication device may be arranged to receive the configuration settings in a communication from an external device over the first wireless network. The electronic wireless communication device may comprise a memory (e.g. a configuration-settings-memory), which may be RAM, arranged to store the configuration settings. The device may be arranged to store the received configuration settings in the memory or the subscriber identity module. For example, the electronic wireless communication device may receive the configuration settings during an attach communication or a tracking area update communication.

In some embodiments, the electronic wireless communication device is arranged to communicate the value of the status indicator to a wireless network (e.g., to the first network, or to a network of the available networks to which the electronic wireless communication device connects after a search). For example, the electronic wireless communication device may communicate the value of the status indicator to the wireless network in a tracking area update request communication.

In some embodiments, the electronic wireless communication device is arranged to communicate the value of the status indicator to a wireless network during an attach request.

In some embodiments, the electronic wireless communication device is arranged to communicate the value of the status indicator to a wireless network after the value of the status indicator has changed (i.e., because the value of the status indicator has changed).

This allows the wireless network to be made aware of whether the electronic wireless communication device has a status of being a moving device, or a stationary device, and to therefore adjust certain operations of the wireless network accordingly, based on this information.

In this way, the setting of a status indicator in the electronic wireless communication device may be beneficially used to alter both the operation of the electronic wireless communication device, as described above, and the operation of an associated wireless network. Thus, according to a third aspect of the present invention, there is provided a communication system comprising:
a wireless communication network; and
an electronic wireless communication device, as described hereinabove, in communication with the communication network;
   wherein the electronic wireless communication device is arranged to communicate the status of the electronic wireless communication device to the wireless communication network, and wherein the wireless communication network is arranged to vary at least one network operation based on the status indicator of the electronic wireless communication device.

Similarly, according to a fourth aspect, there is provided a method of operating a communication system, comprising:
assigning a status indicator of the electronic wireless communication device a value, of at least two values, the at least two values comprising a first value, indicating that the electronic wireless communication device is assigned a status as a moving device, and a second value, indicating that the electronic wireless communication device is assigned a status as a stationary device;
connecting the electronic wireless communication device to a first wireless network;
the electronic wireless communication device searching periodically, at intervals defined by a search period, for available networks of the plurality of wireless networks, other than the first wireless network, wherein the search period has a first period value when the status indicator has a first value, and a second period value when the status indicator has a second value, and wherein the first value is lower than the second value;
the electronic wireless communication device communicating the value of the status indicator to a wireless communication network; and
the wireless communication network varying at least one network operation based on the status indicator of the electronic wireless communication device.

The network varying at least one network operation may comprise the network setting a paging area of the electronic wireless communication device to a limited paging area if the status indicator indicates that the electronic wireless communication device is assigned a status as a stationary device, and setting a paging area of the electronic wireless communication device to a standard paging area if the status indicator indicates that the electronic wireless communication device is assigned a status as a moving device, wherein the limited paging area is smaller than the standard paging area. The paging area may be used as a starting point, i.e. the first area that is paged by the network, so that a smaller area is initially paged in the case of a stationary device compared to a moving device. Alternatively, the paging area may be used as an upper limit, such that the network begins paging a small area, and pages areas progressively increasing in size until either the device responds, or the area that is being paged becomes equal to the set (standard or limited) paging area. This avoids the network paging progressively larger areas searching for the device when it is known to be stationary within a specific area.

In some examples, the paging areas may correspond to tracking areas, or each paging area may be defined by a list of tracking area identities (TAI), e.g. as in LTE. Thus, in some examples, the network may vary a tracking area identity list that is sent to the electronic wireless communication device based on whether the electronic wireless communication device has a status as a stationary device or as a moving device (e.g. just one TAI for a stationary device, and two or more for a moving device).

The electronic wireless communication device may be arranged to update the network of its location only when it moves outside of an area covered by the tracking areas listed on its TAI list (i.e. to initiate a tracking area update procedure when moving to a tracking area that is not in the received TAI list).

Additionally, or alternatively, the network varying at least one network operation may comprise the network varying selection of a mobile management entity based on the status indicator of the electronic wireless communication device.

Features of any aspect or embodiment described herein may, wherever appropriate, be applied to any other aspect or embodiment described herein. Where reference is made to different embodiments or sets of embodiments, it should be understood that these are not necessarily distinct but may overlap. It will furthermore be understood that references made to a method comprising a step correspondingly extend to a module “configured to” carry out a step, and vice versa.

### BRIEF DESCRIPTION OF THE DRAWINGS

An embodiment of the invention will now be described, by way of example only, with reference to the accompanying drawings, in which:

FIG. 1 is a schematic diagram of an exemplary communications network in accordance with an embodiment of the present invention;

FIG. 2 is a flow diagram representing a method according to an embodiment of the present invention;

FIG. 3 is a flow diagram representing a method according to an embodiment of the present invention;

FIG. 4 is a flow diagram showing the stages of an electronic wireless communication device communicating a status indicator value during an attach request; and

FIG. 5 is a flow diagram showing the stages of an electronic wireless communication device communicating a status indicator value after the value of the status indicator has changed.

### DETAILED DESCRIPTION

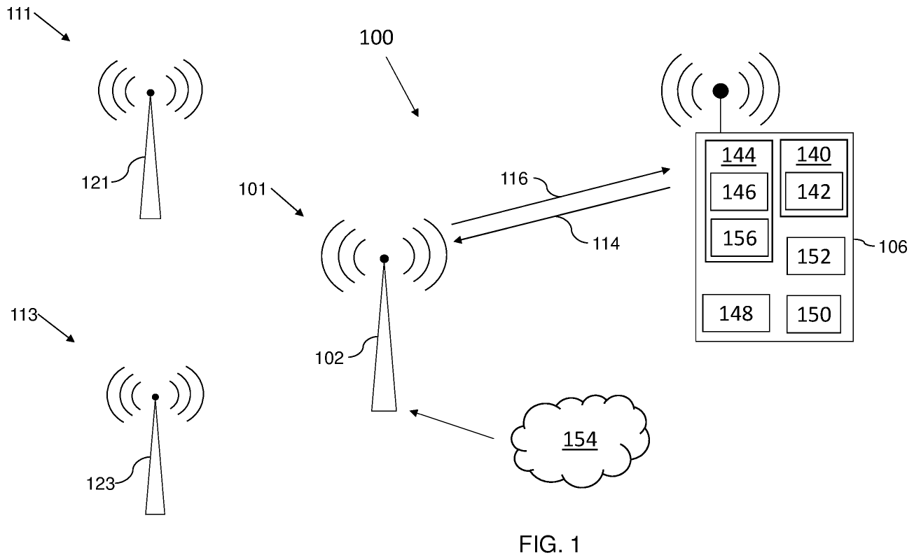

FIG. 1 shows a schematic diagram of an exemplary radio communications system 100. The exemplary radio communications system 100 includes a first network 101, and an electronic wireless communication device 106 (also referred to as user equipment, or UE), which is connected to the first network 101. The first network 101 includes a base station radio transceiver 102. There are also other (second and third) networks 111, 113, each including respective base stations 121, 123, to which the electronic wireless communication device 106 is not presently connected at the time instant represented by FIG. 1.

Each of the base stations 102, 121, 123 and the electronic wireless communication device 106 are arranged to transmit and receive wireless radio signals.

The UE 106 is connected to the first network 101, and therefore the base station 102 is in wireless radio communication with the UE 106, and can thus transmit wireless signals to, and receive wireless signals from the UE 106.

In order to transmit information to the base station 102, the UE 106 transmits a first uplink signal 114 which is addressed to the base station 102, and the base station 102 receives this first uplink signal 114.

In order to transmit information to the UE 106, the base station 102 transmits a first downlink signal 116 which is addressed to the UE 106, and the first UE 106 receives this first downlink signal 116.

The base stations 102, 121, 123 and UE 106 are configured to operate in accordance with a predetermined communication protocol—which in this particular embodiment is LTE, though the principles outlined herein are not limited to LTE and may be equally applied to other predetermined communication protocols e.g. Wi-Fi, Bluetooth, etc.

As described above the UE 106 is connected to the first network 101. However, at some future point in time it may be more appropriate for the UE 106 to instead be connected to the second network 111 or the third network 113. This may be because the UE 106 has moved so that it is out of the range of the first network 101, which is its home network, and is in an area only covered by the second or third network 111, 113. In other words, the UE 106 is roaming to another network. Alternatively, the UE 106 may be using a Mobile Virtual Network Operator (MVNO), a wireless communications provider that doesn't own its own wireless network infrastructure. In this case the UE 106 will not have a “home network” but will connect to various network infrastructures with which the MVNO has agreements. In particular, the UE 106 will connect to the network which is assigned the highest priority of the available networks by the MVNO. Thus, if the second network 111 has a higher priority than the first network 101 then once the UE 106 moves into range for the second network 111 it is desirable that the UE 106 should connect to the second network 111 instead of the first network 101. The priority order of the networks 101, 111, 113 may be determined by the MVNO, for example based on the cost to the UE 106 or to the MVNO for the UE 106 communicating using each of the networks 101, 111, 113.

In order for UEs to be connected to the most appropriate network, they are generally arranged to search periodically for available networks, and to connect to a new, different network (to the one they are already connected to) if a network of higher priority than their current network is identified by the search. Generally, the period at which this search is carried out is defined on the SIM card that is installed in a device, and cannot easily be changed later.

However, in accordance with the present invention, the UE 106 includes a status indicator register 140, in which a status indicator 142 is stored. The status indicator 142 is arranged to have at least two values. These include a first value (e.g., a 0 or 1), indicating that the UE 106 is assigned a status as a moving device, and a second value (e.g., a 0 or 1), indicating that the UE 106 is assigned a status as a stationary device. The status indicator 142 may also be arranged to have additional values (i.e., more than just two). This would allow further information to be conveyed by the status indicator value about the moving state of the device, for example relating to different speeds of movement or devices anticipated to move only short distances.

The UE 106 further includes a subscriber identity module (SIM), which in this example is a universal integrated circuit card (UICC) 144. The UICC 144 assigns an identification to the UE 106, by storing an international mobile subscriber identity (IMSI) number and its related key. The UICC 144 includes a memory 146, in which are stored respective search period values corresponding to each possible value of the status indicator. For example, where two values are possible for the status indicator, the memory 146 may store a first period value, to be used when the status indicator has a first value, corresponding to the UE 106 having a moving status (e.g. 4 hours) and it may store a second period value, to be used when the status indicator has a second value, corresponding to the UE 106 having a stationary status (e.g. 24 hours).

Although in this example the search period values are shown as being stored in a memory 146 of the UICC 144, they may alternatively be stored in a memory (e.g. RAM) elsewhere in the UE 106. For example, the period values may be received over a wireless network, and stored in a memory of the UE. Similarly, the stationary status permission indicator may be stored in a memory of the UE (other than the UICC) and may also be received over the network. These values may be used to override values stored in the UICC 144.

The UE 106 further includes a network searching portion 148. The network searching portion 148 periodically searches for available networks. However, rather than using the same search period (i.e. repeating the network search at fixed intervals) in all conditions, the UE 106 searches at different intervals depending on whether the UE 106 has a status as being a moving device or a stationary device. This allows the UE 106 to search less frequently when it is stationary (or at least when its status is that of a stationary device). This is beneficial since it is very unlikely that a new, higher priority network will have become available to a UE 106 whilst it has remained stationary, and therefore it avoids the need for searching that is unlikely to be useful.

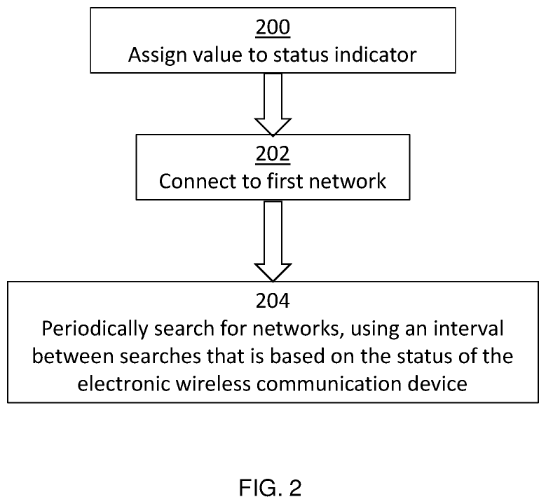

This method carried out by the UE 106 is illustrated in the flow chart of FIG. 2. First at stage 200, the status indicator 142 of the UE 106 is assigned a value, indicating whether the UE 106 is stationary or moving. This assignment can be done in various ways as discussed below. Next, at stage 202, the UE 106 connects to the first network 101. Although shown as being after stage 200, the UE 106 may connect to the network first before a value is assigned to the status indicator, or these steps may occur simultaneously.

Then, at stage 204, the UE 106 (and in particular the network searching portion 148) continues to periodically search for available networks, other than the first network 101, so that it can connect to a more appropriate (e.g. higher priority) network, if one becomes available. The interval at which the searches are carried out is based on the status of the UE 106, such that a first lower value is used if the UE 106 is a moving device (i.e. the searches are carried out more frequently), but if the UE 106 has a status as a stationary device then the searches are carried out less frequently, i.e., at longer intervals.

A value may be assigned to the status indicator in a number of different ways. Firstly, the UE 106 may run an application 150 which allows a user to configure (i.e., select) a value of the status indicator. Thus, the user of the UE 106 inputs into the application 150 whether the device is intended to be a moving device (e.g., a mobile telephone) or a stationary device (e.g., a fixed sensor), and the status indicator value is set to reflect this information. This configuration does not necessarily need to be during initial setup of the device, and could be changed during the lifetime of the UE 106 (e.g., during normal operation). For example, the user may start off intending to use a device 106 as a stationary sensor, and so set the status indicator value accordingly, but then later may decide to attach this sensor to a moving object, for example a car, and may therefore re-configure the status indicator value using the application 150, in order to set it to a value indicating that the UE 106 it now to be treated as a moving device (and therefore to search for networks more regularly).

Alternatively, or in addition, the value of the status indicator may be set based on sensor data collected by the UE 106. The UE 106 may include location and motion sensors 152. For example, the sensor(s) 152 may collect GPS data. Based on this the UE 106 determines whether it is moving or stationary, and sets the value of the status indicator accordingly.

Further, the UE 106 is connected to the network 101. The UE 106 may receive a communication 116 from the base station 102 of the network 101, and set the value of the status indicator based on this received communication. The communication is transmitted from an external device 154, seen in FIG. 1, to the UE 106 over the network 101. The external device may be, for example, a cloud server.

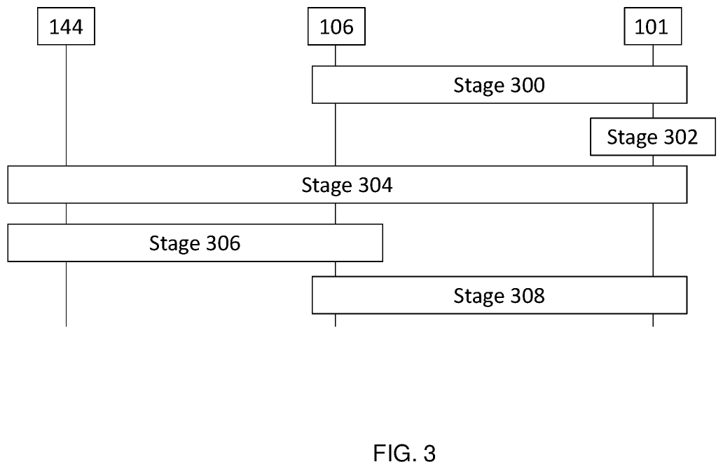

In addition to adjusting its own network searching period based on the value of its status indicator, the UE 106 may also transmit this information to the network 101 or the network may store it when the status is assigned via the network, in order that the network 101 may alter its operation accordingly. This process is represented in the flow diagram of FIG. 3.

For clarity, FIG. 3 shows the UICC 144 separately from the UE 106 even though in reality the UICC 144 is located within the UE 106.

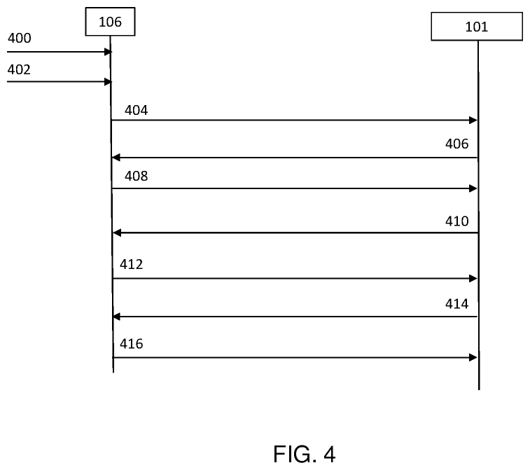

At a first stage 300 the UE 106 connects (i.e., registers) with the network 101, as described above. During this connection process, the value of the status indicator is transmitted to the network 101, as illustrated in greater detail in FIG. 4.

At stage 302, the network 101 alters certain network operations, based on the value of the status indicator that is transmitted from the UE 102. In particular, an indication from the UE 106 that it is stationary may cause the network 101 to select a different mobility management entity (MME) for the UE 106 than would have been selected if it were a moving device. The MME, sometimes called the core network, manages network access and mobility for the UE 106.

The network 101 may also change the paging area of the UE 106 based on receiving an indication that the UE 106 is a stationary device. Generally, if the network 101 pages the device, and receives no response, it will transmit a signal to the device over progressively larger areas (“paging areas”) until a response is received. However, if the network 101 is aware that the device is a stationary device, it may start the paging process using a smaller initial paging area, and/or it may end the paging process when only a smaller area has been paged (i.e. the area in which the stationary device is known to be), since the device is known to be stationary within that area, and therefore paging a larger area is unlikely to cause a response to be received.

Next, at stage 304, the UE 106 may perform an initial search (a “Fast First Higher Priority PLMN search”) for other available networks. The UICC 144 is configured to indicate whether or not this initial search is carried out, and the period for doing so (e.g., 2 minutes after initial connection to the network 101, at stage 300).

Then, at stage 306, the UE 106 checks whether the UICC 144 includes an indication that the UE 106 is permitted to vary its search settings based on having a stationary status. In particular, the UICC 144 stores a stationary status permission indicator 156, as shown in FIG. 1, indicating that the UE 106 is permitted to have a status as a stationary device. The stationary status permission indicator 156 in this example has two values, a first value (e.g. 1) indicates that the UE 106 is permitted to have a status as a stationary device and the second value (e.g., 0) indicates that the UE 106 is not permitted to have a status as a stationary device. If the stationary status permission indicator 156 is set to have a value of 0 then the UE 106 cannot vary the search period from the “standard” value, and therefore it continues to periodically search at the standard intervals. As described above, in other examples than the one illustrated, the stationary status permission indicator is received over the wireless network, and is stored in a memory within the UE 106, typically outside of the UICC.

Alternatively, where it is permitted by the UICC 144, at stage 308 the UE 106 searches for other available networks but only carries out the searches after a longer interval than the standard interval set in the UICC 144. In this example, the longer interval to be used (i.e. the second period value) is set in configuration settings that are stored in the memory 146 of the UICC 144. The memory 146 stores the two possible values of the status indicator (i.e. relating to a moving device and a stationary device) and in association with each stores a corresponding period value. The UE 106 therefore sets the search interval by retrieving the second period value from the memory 146.

This arrangement allows the search period to be varied by the UE 106 itself. An alternative might be for a network operator to supply different types of SIM cards (e.g. one for stationary devices and one for moving devices) with different search periods configured on each. However, this is undesirable since the network operator has limited control over which device the SIM ultimately ends up in, and therefore the search period could be inappropriate for the chosen device. Furthermore, some devices may change during their usage lifetime from being stationary to moving, or vice versa, and in that case the search period pre-configured on the SIM card would not be appropriate. The described method overcomes these issues.

FIG. 4 is a flow diagram showing stage 300 of FIG. 3 in greater detail. At a first stage 400, the value of the status indicator for the UE 106 is set. Then the UE 106, at stage 402, begins communicating with the network 101.

In order to initiate a connection with the network 101, the UE 106 transmits an attach request 404 to the network 101. This includes a bit which indicates the value of the status indicator (or alternatively may only include the additional status bit if the status is that of a stationary device).

In response, the network 101 sends to the UE 106 an authentication request 406. In response to this, the UE 106 returns an authentication response 408. The network 101 then issues to the UE 106 a security mode command 410, and in response receives a signal 412 indicating that the security mode is complete. During these stages 410, 412 security algorithms for integrity protection and ciphering are negotiated.

The network 101 then sends to the UE 106 an attach accept signal 414, indicating that it has accepted the request to connect to the network 101. In some examples this attach accept signal 414 may further include the stationary status permission indicator and/or a second period value (i.e. the search period to be used when the device is stationary). In response to receiving this signal, the UE 106 transmits back to the network 101 an acknowledgement 416 that the attach process is complete.

Once this communication has been carried out, the network 101 is aware that the UE 106 is a stationary device (if that indeed is the case) and is able to adjust the operations of the network 101 accordingly, as described above.

As further described above, the value of the status indicator may be altered during the lifetime of a UE 106, for example whilst it is connected to a particular network 101. In this case it is important that the network 101 is notified of this change, so that it can adjust its operations as appropriate.

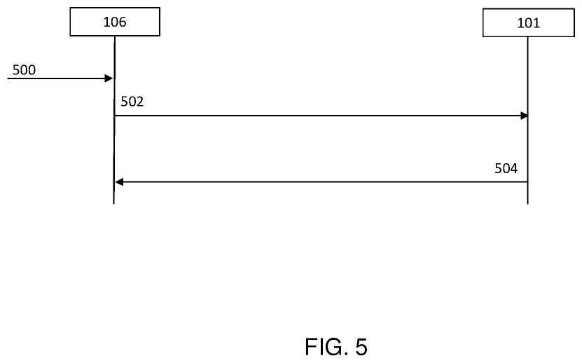

This process is illustrated in the flow diagram of FIG. 5. First, at stage 500, the value of the status indicator is changed, by any of the means described above. For example, the sensors 152 may detect that a previously stationary device has just started moving, and may therefore change the value of the status indicator.

Next, at stage 502, the UE 106 transmits an update signal to the network 101, including a bit which indicates the value of the status indicator, but in this case the bit clearly has a different value to in the example described above with reference to FIG. 4, since the device now has a moving status rather than a stationary status.

In response to this, the UE 106 receives an acknowledgement 504 from the network 101. In other examples, this acknowledgement 504 may also include the stationary status permission indicator, and the second period value. As a result of receiving this signal, the network 101 can then adjust the network operations back to being those that are used for a moving device.

1. An electronic wireless communication device arranged to connect to a first wireless network of a plurality of wireless networks, the electronic wireless communication device comprising:
a status indicator having at least two values, comprising a first value indicating that the electronic wireless communication device is assigned a status as a moving device and a second value indicating that the electronic wireless communication device is assigned a status as a stationary device;
wherein the electronic wireless communication device is arranged to periodically search, at intervals defined by a search period, for available networks of the plurality of wireless networks, other than the first wireless network to which the electronic wireless communication device is connected; and
wherein the search period has a first period value when the status indicator has the first value and a second period value when the status indicator has the second value, and wherein the first period value is lower than the second period value.

2. The electronic wireless communication device as claimed in claim 1, wherein the first period value is less than 4 hours and wherein the second period value is more than 1 day.

3. The electronic wireless communication device as claimed in claim 1, wherein the value of the status indicator is user configurable.

4. The electronic wireless communication device as claimed in claim 1, wherein the value of the status indicator is configurable based on device data of the electronic wireless communication device.

5. The electronic wireless communication device as claimed in claim 1, wherein the value of the status indicator is configurable based on a communication received from an external device over the first wireless network.

6. The electronic wireless communication device as claimed in claim 1, wherein the electronic wireless communication device is arranged to connect to a highest priority network of the available networks identified in a search.

7. The electronic wireless communication device as claimed in claim 1, wherein the electronic wireless communication device comprises a subscriber identity module which assigns an identification to the electronic wireless communication device.

8. The electronic wireless communication device as claimed in claim 7, wherein the subscriber identity module stores a stationary status permission indicator, indicating that the electronic wireless communication device is permitted to have a status as a stationary device.

9. The electronic wireless communication device as claimed in claim 7, wherein the subscriber identity module stores configuration settings associated with the electronic wireless communication device being assigned a status as a stationary device.

10. The electronic wireless communication device as claimed in claim 1, wherein the electronic wireless communication device is arranged to receive a stationary status permission indicator, indicating that the electronic wireless communication device is permitted to have a status as a stationary device, in a communication from an external device over the first wireless network.

11. The electronic wireless communication device as claimed in claim 1, wherein the electronic wireless communication device is arranged to receive the configuration settings associated with the electronic wireless communication device being assigned a status as a stationary device in a communication from an external device over the first wireless network.

12. The electronic wireless communication device as claimed in claim 1, wherein the electronic wireless communication device is arranged to communicate the value of the status indicator to a wireless network.

13. The electronic wireless communication device as claimed in claim 12, wherein the electronic wireless communication device is arranged to communicate the value of the status indicator to the wireless network during an attach request.

14. The electronic wireless communication device as claimed in claim 12, wherein the electronic wireless communication device is arranged to communicate the value of the status indicator to the wireless network after the value of the status indicator has changed.

15. A communication system comprising:
a wireless communication network; and
the electronic wireless communication device as claimed in claim 1, in communication with the communication network;
wherein the electronic wireless communication device is arranged to communicate the status of the electronic wireless communication device to the wireless communication network, and wherein the wireless communication network is arranged to vary at least one network operation based on the status indicator of the electronic wireless communication device.

16. The communication system as claimed in claim 15, wherein the network varying at least one network operation comprises the network setting a paging area of the electronic wireless communication device to a limited paging area if the status indicator indicates that the electronic wireless communication device is assigned a status as a stationary device, and setting a paging area of the electronic wireless communication device to a standard paging area if the status indicator indicates that the electronic wireless communication device is assigned a status as a moving device, wherein the limited paging area is smaller than the standard paging area.

17. The communication system as claimed in claim 15, wherein the network varying at least one network operation comprises the network varying selection of a mobile management entity based on the status indicator of the electronic wireless communication device.

18. A method of operating an electronic wireless communication device, comprising:
assigning a status indicator of the electronic wireless communication device a value, of at least two values, the at least two values comprising a first value indicating that the electronic wireless communication device is assigned a status as a moving device and a second value indicating that the electronic wireless communication device is assigned a status as a stationary device;
connecting the electronic wireless communication device to a first wireless network; and
the electronic wireless communication device searching periodically, at intervals defined by a search period, for available networks of the plurality of wireless networks, other than the first wireless network, wherein the search period has a first period value when the status indicator has the first value and a second period value when the status indicator has the second value, and wherein the first period value is lower than the second period value.
